(19) United States
(12) Patent Application Publication
(10) Pub. No.: US 2003/0126795 A1
(43) Pub. Date: Jul. 10, 2003

(54) Water cultivation technology and water cultivation system of plant

(76) Inventor: Chien-Chou Lai, Taichung County (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/042,037

(22) Filed: Jan. 10, 2002

(51) Int. Cl. A01G 31/00

(52) U.S. Cl. 47/63

(57) ABSTRACT

The present invention relates to a water cultivation technology of a plant, including: cultivation in an isolated manner, and achieving an air exposure and oxygen solution effect automatically. The present invention relates to a water cultivation system of a plant, including a plurality of cultivation boxes arranged in a separate and isolated manner. Each of the cultivation boxes has a hollow inner portion provided with a plurality of spaced support ribs each having a top face. The top face of each of the support ribs has a height greater than that a bottom face of the cultivation box, with a determined distance being defined between the top face of each of the support ribs and the bottom face of the cultivation box.

### BACKGROUND OF THE INVENTION

1. Field of the Invention

The present invention relates to a water cultivation technology and a water cultivation system of a plant, and more particularly to a water cultivation system having a horizontal adjusting mechanism.

2. Description of the Related Art

A conventional water cultivation technology includes providing a water cultivation pool of a large area, so that multiple cultivation sponges containing seeds therein may be placed in the water cultivation pool. The cultivation liquid, such as a mixture of water, fertilizer and pesticide, may be put into the water cultivation pool, so that the seeds in the cultivation sponges may sprout and grow.

However, the cultivation sponges are disposed at the bottom of the water cultivation pool, so that the roots of the seeds in the cultivation sponges are always immersed in the cultivation liquid. Thus, the air exposure and the oxygen solution effect of the cultivation sponges is very poor. In addition, all of the cultivation sponges are placed in the same water cultivation pool, so that the infection of plant easily largely expands and spreads.

### SUMMARY OF THE INVENTION

The primary objective of the present invention is to provide a water cultivation technology and a water cultivation system, wherein by provision of the support ribs, the cultivation box may achieve an air exposure and oxygen solution effect automatically, without having to provide a pump additionally.

Another objective of the present invention is to provide a water cultivation technology and a water cultivation system, wherein the water cultivation system employs an isolated design, whereby the cultivation boxes are arranged in an isolated manner. Thus, each of the cultivation boxes may be provided with a controller so as to control the liquid volume of each of the cultivation boxes individually, so that the cultivation boxes may be used to cultivate plants having different states of growth.

A further objective of the present invention is to provide a water cultivation technology and a water cultivation system, wherein the cultivation boxes do not communicate with each other, so that the cultivation boxes may be used to cultivate the plant in an isolated manner, thereby preventing the infection from largely expanding and spreading.

In accordance with a first aspect of the present invention, there is provided a water cultivation technology of a plant, comprising:

cultivation in an isolated manner:

providing a plurality of independent cultivation boxes arranged in a separate and isolated manner, the cultivation boxes not communicating with each other; and

achieving an air exposure and oxygen solution effect automatically:

providing a plurality of cultivation sponges in each of the cultivation boxes, a bottom face of each of the cultivation sponges having a height greater than that of a bottom face of the cultivation box;

wherein, when a level of a cultivation liquid in the cultivation box is lower than that of the bottom face of each of the cultivation sponges, a root of a plant is exposed to contact air, and when the level of a cultivation liquid in the cultivation box is lifted to be higher than that of the bottom face of each of the cultivation sponges, an oxygen solution effect is produced so as to increase an oxygen content of the cultivation liquid, thereby achieving an air exposure and oxygen solution effect automatically.

In accordance with a second aspect of the present invention, there is provided a water cultivation system of a plant, comprising:

a plurality of cultivation boxes arranged in a separate and isolated manner, each of the cultivation boxes having a hollow inner portion provided with a plurality of spaced support ribs each having a top face, the top face of each of the support ribs having a height greater than that a bottom face of the cultivation box, with a determined distance being defined between the top face of each of the support ribs and the bottom face of the cultivation box.

In accordance with a third aspect of the present invention, the water cultivation system comprises a horizontal adjusting mechanism mounted on a bottom face of each of the cultivation boxes, for adjusting the inclined angle of each of the cultivation boxes.

In accordance with a fourth aspect of the present invention, the water cultivation system further comprises a horizontal adjusting mechanism mounted on a bottom face of the work table, for adjusting the inclined angle of the work table.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a cultivation box of a water cultivation system of a plant in accordance with a first embodiment of the present invention;

FIG. 2 is a perspective assembly view of the cultivation box of the water cultivation system of a plant as shown in FIG. 1;

FIG. 3 is a plan cross-sectional view of the cultivation box of the water cultivation system of a plant as shown in FIG. 2;

FIG. 4 is a schematic operational view of the cultivation box of the water cultivation system of a plant as shown in FIG. 3 in use;

FIG. 5 is a schematic operational view of the cultivation box of the water cultivation system of a plant as shown in FIG. 4 in use;

FIG. 6 is a top plan view of the water cultivation system of a plant in accordance with the first embodiment of the present invention;

FIG. 7 is a perspective view of a cultivation box of a water cultivation system of a plant in accordance with a second embodiment of the present invention;

FIG. 8 is a plan cross-sectional view of the cultivation box of the water cultivation system of a plant as shown in FIG. 7;

FIG. 9 is a schematic operational view of the cultivation box of the water cultivation system of a plant as shown in FIG. 8 in use; and

FIG. 10 is a perspective view of a water cultivation system of a plant in accordance with a third embodiment of the present invention

### DETAILED DESCRIPTION OF THE INVENTION

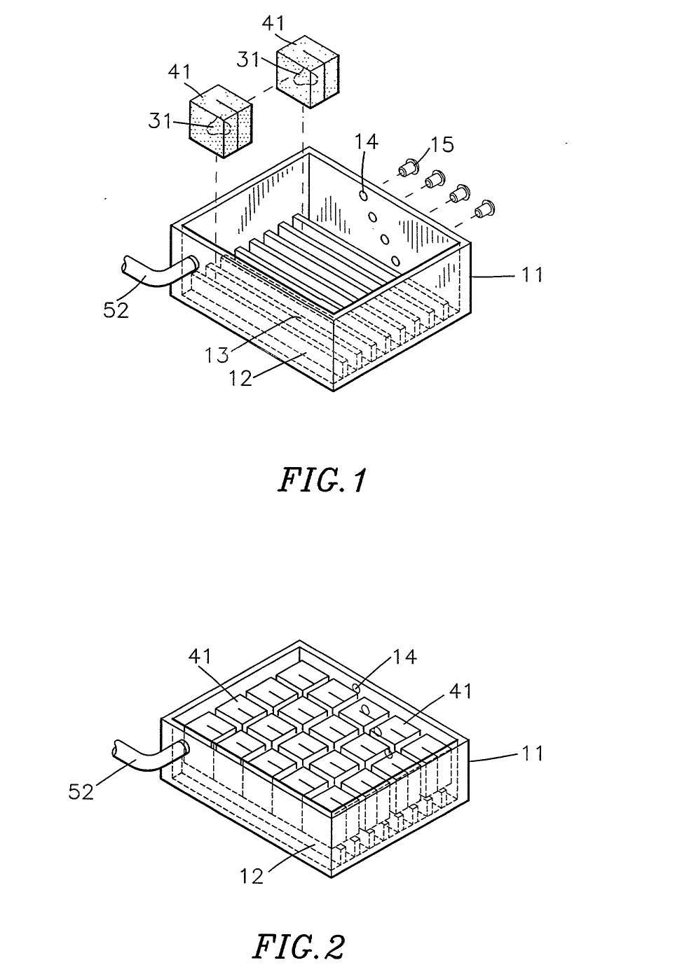

Referring to the drawings and initially to FIGS. 1, 2 and 6, a water cultivation system of a plant in accordance with a first embodiment of the present invention comprises a work table 30, a plurality of support racks 31 mounted on the work table 30, a plurality of separate and isolated cultivation boxes 11 mounted on each of the support racks 31, and a supply device 5 connected between the support racks 31.

The supply device 5 includes a supply tank 53, a plurality of supply pipes 51 each mounted on each of the support racks 31 of the work table 30 and each connected to the supply tank 53, and a plurality of branch pipes 52 each connected between one of the supply pipes 51 and one of the cultivation boxes 11, so that the liquid cultivation material or cultivation liquid, such as a mixture of water, fertilizer and pesticide, contained in the supply tank 53 may be conveyed through the supply pipes 51 and the branch pipes 52 into the cultivation boxes 11, for cultivating the plant contained in the cultivation boxes 11. Preferably, each of the supply pipes 51 is located between two adjacent support racks 31 on the work table 30, and is provided with a plurality of branch pipes 52 each connected to a respective one of the cultivation boxes 11.

As shown in FIGS. 1 and 2, each of the cultivation boxes 11 has a hollow inner portion provided with a plurality of spaced support ribs 12 each having a top face 13. The top face 13 of each of the support ribs 12 is higher than a bottom face of the cultivation box 11, with a determined distance being defined between the top face 13 of each of the support ribs 12 and the bottom face of the cultivation box 11.

Each of the cultivation boxes 11 has a side wall formed with a plurality of drain holes 14 which are arranged in an oblique manner, so that each of the drain holes 14 is located at a different height. A plurality of stop plugs 15 are detachably and removably mounted in the drain holes 14 of the cultivation box 11 respectively.

A plurality of cultivation sponges 41 are received in each of the cultivation boxes 11, and are supported by the top faces 13 of the support ribs 12 of each of the cultivation boxes 11, so that a bottom face of each of the cultivation sponges 41 is higher than the bottom face of the cultivation box 11, with a determined distance being defined between the bottom face of each of the cultivation sponges 41 and the bottom face of the cultivation box 11. Each of the cultivation sponges 41 contains a seed 31 of a plant therein.

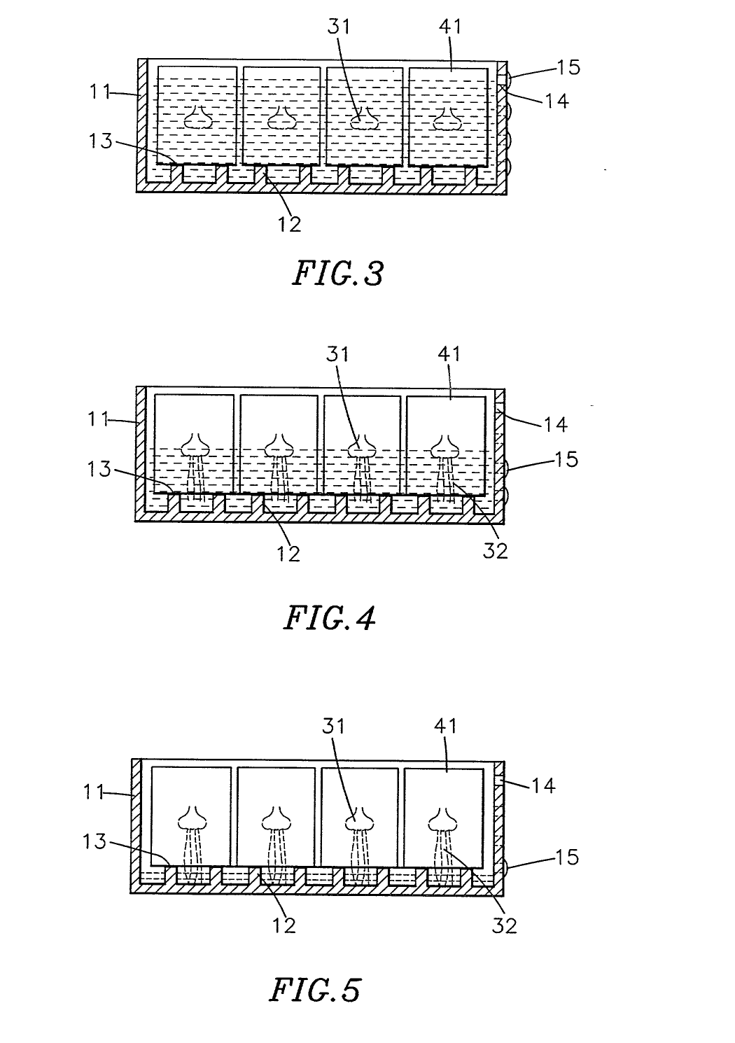

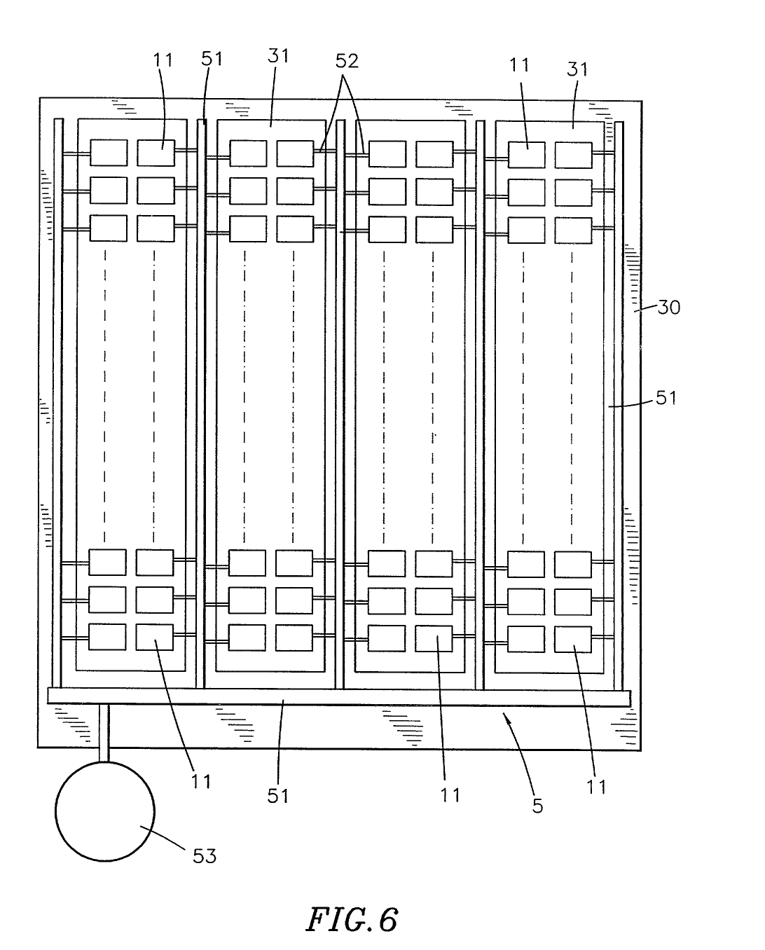

As shown in FIGS. 3 and 6, the liquid cultivation material (or cultivation liquid) contained in the supply tank 53 may be conveyed through the supply pipes 51 and the branch pipes 52 into each of the cultivation boxes 11. Thus, the liquid cultivation material is filled with the cultivation box 11, so that the cultivation sponges 41 are immersed in the liquid cultivation material as shown in FIG. 3.

As shown in FIG. 4, some of the stop plugs 15 are removed from the drain holes 14 of the cultivation box 11, thereby draining some of the liquid cultivation material through the drain holes 14 of the cultivation box 11, so that the cultivation sponges 41 are partially exposed outward from the level of the liquid cultivation material.

Thus, the stop plugs 15 may block the drain holes 14 at different locations, thereby adjusting the level of the liquid cultivation material, so as to satisfy different requirements of growth of the plant.

As shown in FIG. 5, the level of the liquid cultivation material is lower than the bottom face of each of the cultivation sponges 41, and is still higher than the bottom face of the cultivation box 11, so that a space is formed between the bottom face of each of the cultivation sponges 41 and the level of the liquid cultivation material. After the space is formed, the space is filled with air, so that the root 32 of the seed 31 contained in the cultivation sponge 41 may contact the air, thereby facilitating the root 32 of the seed 31 proceeding a breath effect.

Then, the level of the liquid cultivation material may be gradually lifted to the position as shown in FIG. 4 or further to the position as shown in FIG. 3, so that the air contained in the space between the bottom face of the cultivation sponge 41 and the level of the liquid cultivation material may be moved with increase of the level of the liquid cultivation material, thereby producing an oxygen solution effect, so as to increase the oxygen content of the liquid cultivation material automatically.

Accordingly, the top face 13 of each of the support ribs 12 is higher than the bottom face of the cultivation box 11, so that the root 32 of the seed 31 may be exposed outward from the level of the liquid cultivation material when the level of the liquid cultivation material is lowered, while the oxygen may be dissolved into the liquid cultivation material when the level of the liquid cultivation material is lifted, to aid breath of the root 32 of the seed 31. Thus, by provision of the support ribs 12, the cultivation box 11 may achieve an air exposure and oxygen solution effect automatically, without having to provide a pump additionally.

In addition, the water cultivation system in accordance with the present invention employs an isolated design, whereby the cultivation boxes 11 are arranged independently in an isolated manner. Thus, the branch pipe 52 on each of the cultivation boxes 11 may be provided with a controller so as to control the liquid volume of each of the cultivation boxes 11 individually, so that the cultivation boxes 11 may be used to cultivate plants having different states of growth.

Further, the cultivation boxes 11 are arranged independently in an isolated manner, so that the cultivation boxes 11 do not communicate with each other. Thus, the cultivation boxes 11 may be used to cultivate the plants in an isolated manner, thereby preventing infection from largely expanding and spreading.

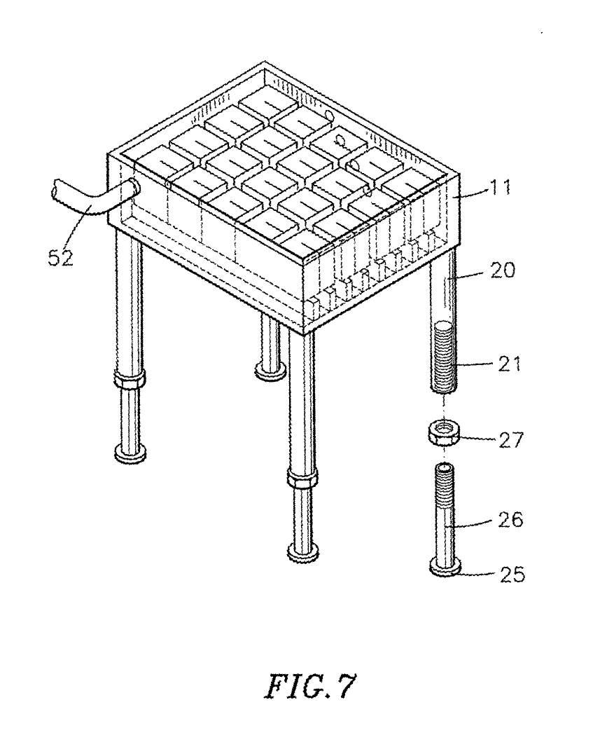

Referring to FIGS. 7-9, the water cultivation system in accordance with a second embodiment of the present invention comprises a horizontal adjusting mechanism mounted on the bottom face of each of the cultivation boxes 11.

The horizontal adjusting mechanism includes four upright posts 20, four adjusting bolts 26 each adjustably mounted on a respective one of the four upright posts 20, and four urging nuts 27 each urged on a respective one of the four adjusting bolts 26.

Each of the four upright posts 20 has an upper portion secured on the bottom face 110 of each of the cultivation boxes 11, and has a lower portion formed with a screw portion 21.

Each of the four adjusting bolts 26 has an upper portion rotatably screwed into the screw portion 21 of the respective upright post 20, and has a lower portion provided with an adjusting disk 25.

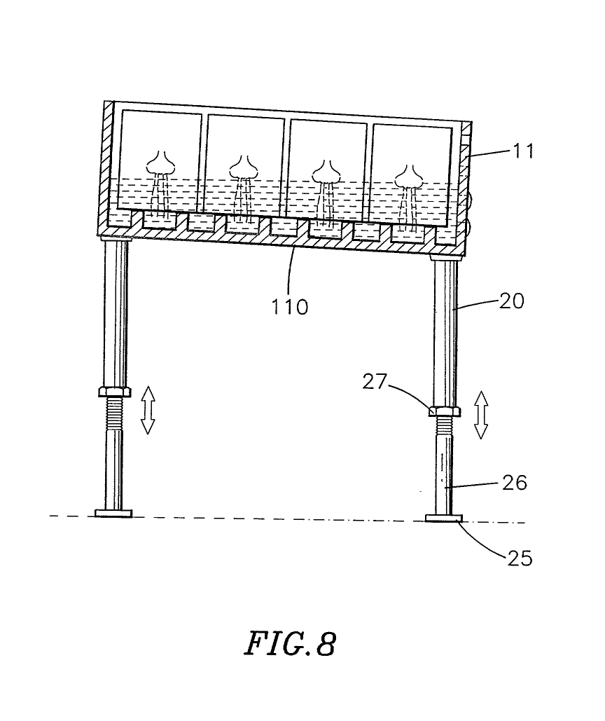

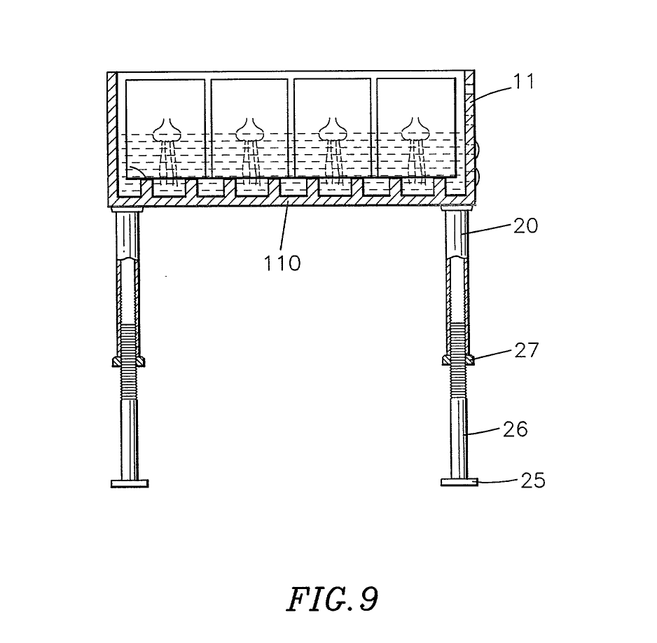

In operation, when the bottom face 110 of the cultivation box 11 is disposed at an inclined state as shown in FIG. 8, the urging nut 27 on the adjusting bolts 26 may be loosened, whereby the adjusting disk 25 may be rotated relative to the upright post 20, so that the adjusting bolt 26 may be rotated to retract into or extend outward from the screw portion 21 of the respective upright post 20, so as to adjust the total length of the upright post 20 and the adjusting bolt 26, thereby adjusting the inclined angle of the bottom face 110 of the cultivation box 11, so that the bottom face 110 of the cultivation box 11 may be disposed at a horizontal state as shown in FIG. 9. Then, the urging nut 27 may urge the adjusting bolt 26 again.

Accordingly, the cultivation box 11 may be disposed at a horizontal state by adjusting the relative position between the upright post 20 and the adjusting bolt 26.

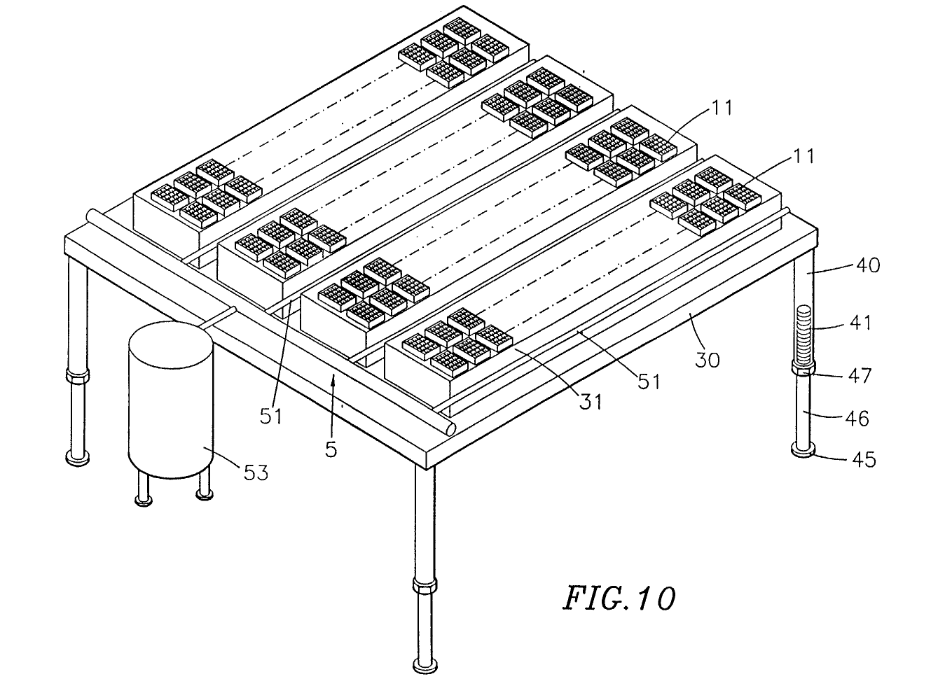

Referring to FIG. 10, the water cultivation system in accordance with a third embodiment of the present invention comprises a horizontal adjusting mechanism mounted on the bottom face of the work table 30 that is used to support the cultivation boxes 11.

The horizontal adjusting mechanism includes four upright posts 40, four adjusting bolts 46 each adjustably mounted on a respective one of the four upright posts 40, and four urging nuts 47 each urged on a respective one of the four adjusting bolts 46.

Each of the four upright posts 40 has an upper portion secured on the bottom face of the work table 30, and has a lower portion formed with a screw portion 41.

Each of the four adjusting bolts 46 has an upper portion rotatably screwed into the screw portion 41 of the respective upright post 40, and has a lower portion provided with an adjusting disk 45.

In operation, when the bottom face of the work table 30 is disposed at an inclined state, the urging nut 47 on the adjusting bolts 46 may be loosened, whereby the adjusting disk 45 may be rotated relative to the upright post 40, so that the adjusting bolt 46 may be rotated to retract into or extend outward from the screw portion 41 of the respective upright post 40, so as to adjust the total length of the upright post 40 and the adjusting bolt 46, thereby adjusting the inclined angle of the bottom face of the work table 30, so that the bottom face of the work table 30 may be disposed at a horizontal state. Then, the urging nut 47 may urge the adjusting bolt 46 again.

Accordingly, the work table 30 may be disposed at a horizontal state by adjusting the relative position between the upright post 40 and the adjusting bolt 46.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A water cultivation technology of a plant, comprising:
cultivation in an isolated manner:
providing a plurality of independent cultivation boxes arranged in a separate and isolated manner, the cultivation boxes not communicating with each other; and
achieving an air exposure and oxygen solution effect automatically:
providing a plurality of cultivation sponges in each of the cultivation boxes, a bottom face of each of the cultivation sponges having a height greater than that of a bottom face of the cultivation box;
wherein, when a level of a cultivation liquid in the cultivation box is lower than that of the bottom face of each of the cultivation sponges, a root of a plant is exposed to contact air, and when the level of a cultivation liquid in the cultivation box is lifted to be higher than that of the bottom face of each of the cultivation sponges, an oxygen solution effect is produced so as to increase an oxygen content of the cultivation liquid, thereby achieving an air exposure and oxygen solution effect automatically.

2. A water cultivation system of a plant, comprising:
a plurality of cultivation boxes arranged in a separate and isolated manner, each of the cultivation boxes having a hollow inner portion provided with a plurality of spaced support ribs each having a top face, the top face of each of the support ribs having a height greater than that a bottom face of the cultivation box, with a determined distance being defined between the top face of each of the support ribs and the bottom face of the cultivation box.

3. The water cultivation system of a plant in accordance with claim 2, further comprising a level control structure mounted in each of the cultivation boxes, for controlling a level of liquid in each of the cultivation boxes.

4. The water cultivation system of a plant in accordance with claim 3, wherein the level control structure includes a plurality of drain holes formed in a side wall of each of the cultivation boxes, and each of the drain holes 14 are arranged in an oblique manner, so that each of the drain holes is located at a different height.

5. The water cultivation system of a plant in accordance with claim 4, wherein the level control structure includes a plurality of stop plugs detachably and removably mounted in the drain holes of the cultivation box respectively.

6. The water cultivation system of a plant in accordance with claim 2, further comprising a plurality of cultivation sponges received in each of the cultivation boxes, and supported by the top faces of the support ribs of each of the cultivation boxes, so that a bottom face of each of the cultivation sponges has a height greater than that of the bottom face of the cultivation box with a determined distance being defined between the bottom face of each of the cultivation sponges and the bottom face of the cultivation box.

7. The water cultivation system of a plant in accordance with claim 2, further comprising a work table, a plurality of support racks mounted on the work table to support the cultivation boxes, and a supply device connected between the support racks.

8. The water cultivation system of a plant in accordance with claim 7, wherein the supply device includes a supply tank, a plurality of supply pipes each mounted on each of the support racks of the work table and each connected to the supply tank, and a plurality of branch pipes each connected between one of the supply pipes and one of the cultivation boxes, so that cultivation material contained in the supply tank is conveyed through the supply pipes and the branch pipes into the cultivation boxes.

9. The water cultivation system of a plant in accordance with claim 2, further comprising a horizontal adjusting mechanism mounted on a bottom face of each of the cultivation boxes.

10. The water cultivation system of a plant in accordance with claim 9, wherein the horizontal adjusting mechanism includes a plurality of upright posts, a plurality of adjusting bolts each adjustably mounted on a respective one of the upright posts, and a plurality of urging nuts each urged on a respective one of the adjusting bolts.

11. The water cultivation system of a plant in accordance with claim 10, wherein each of the upright posts has an upper portion secured on the bottom face of each of the cultivation boxes, and has a lower portion formed with a screw portion.

12. The water cultivation system of a plant in accordance with claim 11, wherein each of the adjusting bolts has an upper portion rotatably screwed into the screw portion of the respective upright post, and has a lower portion provided with an adjusting disk.

13. The water cultivation system of a plant in accordance with claim 7, further comprising a horizontal adjusting mechanism mounted on a bottom face of the work table.

14. The water cultivation system of a plant in accordance with claim 13, wherein the horizontal adjusting mechanism includes a plurality of upright posts, a plurality of adjusting bolts each adjustably mounted on a respective one of the upright posts, and a plurality of urging nuts each urged on a respective one of the adjusting bolts.

15. The water cultivation system of a plant in accordance with claim 14, wherein each of the upright posts has an upper portion secured on the bottom face of the work table, and has a lower portion formed with a screw portion.

16. The water cultivation system of a plant in accordance with claim 15, wherein each of the adjusting bolts has an upper portion rotatably screwed into the screw portion of the respective upright post, and has a lower portion provided with an adjusting disk.
